(19) United States
(12) Patent Application Publication
(10) Pub. No.: US 2008/0215394 A1
(43) Pub. Date: Sep. 4, 2008

(54) SYSTEM AND METHOD FOR QUALIFICATION AND APPROVAL OF PRODUCT PLACEMENT MARKETING CONTENT

(76) Inventor: Timothy L. McLaughlin, Vienna, VA (US)

Correspondence Address: FOLEY & LARDNER LLP, 150 EAST GILMAN STREET, P.O. BOX 1497, MADISON, WI, 53701-1497, US

(21) Appl. No.: 12/024,586

(22) Filed: Feb. 1, 2008

Related U.S. Application Data
(60) Provisional application No. 60/899,022, filed on Feb. 2, 2007.

(51) Int. Cl. G06Q 30/00

(52) U.S. Cl. 705/7; 705/1

(57) ABSTRACT

A system and method that provides for the objective qualification and approval of product placement marketing content, based on defined impression parameters, so that advertisers and brand managers can maintain their brands while expanding their suppliers and their reach into online video content and distribution.

### CROSS-REFERENCE TO RELATED PATENT APPLICATIONS

The present application relates to U.S. Provisional Patent Application 60/899,022, filed on Feb. 2, 2007, and entitled “Video Commission System,” which is incorporated herein in its entirety and forms a basis for a claim of priority.

### FIELD

Embodiments of the present application relate to the field of marketing systems. Exemplary embodiments relate to a system and method for the objective qualification and approval of product placement marketing content through the use of impression parameters.

### BACKGROUND

The use of online marketplaces for matching advertisers and brand managers to independent producers of marketing content (video, audio, and/or graphics) is relatively new. The commissioned production of content with product placement or brand-associated content is even less common. One reason holding back this field is that there are few, if any, ways for the marketer to gauge or measure the effectiveness of their advertising spend. In traditional TV advertising, the advertiser knows the number of people watching the show as well as the demographics associated with the audience. This does not hold true with Internet based delivery on sites such as YouTube or MySpace. Furthermore, when product placement is concerned, there are no systems in place to help advertisers gauge the relative effectiveness of the content to be delivered.

Recently, some web sites have emerged that were developed to match advertisers and brand managers to creatives. Examples include but are not limited to www.brandfame.com and www.bootb.com. Each of these sites uses traditional advertising requirements to scope the creation of content such as project objective, target market, and/or value proposition. None provide additional impression parameters that this patent application specifies in the following section.

### SUMMARY

Aspects of the exemplary embodiments are directed to the objective qualification and approval of product placement marketing content, based on a set of parameters and specified requirements, so that advertisers and brand managers can maintain their brands while expanding their suppliers and their reach into online video content and distribution.

In one exemplary embodiment, an advertisement evaluation method is presented which includes receiving a produced advertisement from a producer; evaluating the advertisement based on a set of parameters and specified requirements; producing a result of the evaluation; forwarding the advertisement to an advertiser if the result is acceptable; and returning the advertisement to the producer if the result is not acceptable.

In another exemplary embodiment, an advertisement evaluation system is, presented which includes a device configured to receive a produced advertisement from a producer, evaluate the advertisement based on a set of parameters and specified requirements to produce a result, and forward the advertisement to an advertiser if the result is acceptable and return the advertisement to the producer if the result is not acceptable.

In another exemplary embodiment, an advertising management method is presented which includes receiving a request for a desired advertisement from an advertiser, wherein the request includes a specification of requirements for the desired advertisement; forwarding the request to a producer if the request selected by the producer; producing the selected advertisement according to the specified requirements, evaluating the advertisement based on the specified requirement and a set of parameters; reviewing the advertisement by the advertiser; displaying the accepted advertisement; tracking the performance of the accepted advertisement; charging the advertiser based on the performance; receiving a payment for the charges; and forwarding at least a portion of the payment to the producer.

In yet another exemplary embodiment, an advertisement management system is presented which includes a device configured to receive a request for a desired advertisement from an advertiser, wherein the request comprises of a specification of the requirements for the desired advertisement, and allow a producer to select and fetch the request. The system further is configured to receive a produced advertisement from the producer, to evaluate the advertisement based on the specified requirement and a set of parameters, and to forward the advertisement to advertiser to reviewer. The system displays the advertisement, tracks a performance of the advertisement; charges the advertiser based on the performance, receives a payment for the charges; and forwards at least a portion of the payment to the producer.

These and other features, aspects and advantages will become apparent from the following description, appended claims, and the accompanying exemplary embodiments shown in the drawings, which are briefly described below.

### BRIEF DESCRIPTION OF THE DRAWINGS

FIG. 1 is a diagram depicting a system for on-line advertising management and evaluation according to an exemplary embodiment.

FIG. 2 is a flow diagram of operations performed involving the system of FIG. 1 according to an exemplary embodiment.

FIG. 3 is an exemplary image taken from a “Create a new Commission” section of the system of FIG. 1 illustrating how brand managers can use the system to specify impression parameters to more clearly define an output for their commission.

FIG. 4 is an exemplary image of a screen for approving or rejecting a video, used in the system of FIG. 1.

FIG. 5 is another exemplary image of a video having a placed product part of an advertising campaign.

FIG. 6 is another exemplary image of the video of FIG. 5.

FIG. 7 is another exemplary image of the video of FIG. 5.

### DETAILED DESCRIPTION

Exemplary embodiments are described below with reference to the accompanying drawings. It should be understood that the following description is intended to describe exemplary embodiments, and not to limit the invention defined in the appended claims.

In general, the embodiments described below present a technique for defining and quantifying the effectiveness of product placement contents by defining impression parameters and associating and evaluating those parameters within the delivered contents.

Exemplary embodiments are described below. While these embodiments are described as operating in an online environment, it should not be construed that all embodiments are in any way limited to an online implementation. The embodiments may be implemented within an off-line business that matches brands to independent producers of product placement content using paper or other electronic means.

One embodiment involves a marketplace in which advertisers, marketers, and brand managers can connect with freelance video producers who then create innovative product placement videos tailored for online delivery and consumption. Advertisers and brand managers, wishing to raise awareness for their brand, commission the development of videos through this online marketplace. Video producers register on the system and find video commissions that they choose to create content for and then submit that content against the commissions set up by the advertisers.

The described system provides the tools that allow the brand manager to define the various characteristics required to meet their demands/requirements for the commissioned content. These requirements include the normal parameters usually associated with advertising and branded content such as project objective, target market, and/or value proposition. In addition, the system captures additional impression parameters not currently associated with product placement commissions. These include, but are not limited to, the percentage of the screen that the product is, displayed in, the amount of time the product is shown in the video, the length of the video, the tone of the video (e.g, happy, sad, funny, scary, etc.), the size of the video, the video frame rate, etc.

When a brand manager signs up with the system and creates a commission for a piece of content, he or she defines what parameters he or she is looking for with regards to the use of product placement, as mentioned above. Brand managers can use the preset parameters already included in the system, or can create their own commission specific parameters and metrics.

These metrics are available to the candidate of content producers so that they can develop content to these specifications. Once the producer submits his or her piece of content for review, the system uses the previously collected data/requirements to determine if the submitted video meets the requirements of the requestor. If the video meets the requirements, then it is forwarded on to the requester. If not, the video is rejected and the producer is notified of the reasons for the rejection.

Alternative embodiments for providing this characterization and classification system include, but are not limited to, paper-based matching, spreadsheets, or traditional client-server applications. These tools, while less extensive than an on-line system, could nevertheless be used to match characteristics and parameters to classify the promotional contents of a given piece of media such as a video.

By putting the system online, the potential pool of content producers may be increased. Additionally, in putting the service online, many of the business process steps can be automated. For example, using image processing techniques, it is possible to automatically/systematically quantify the amount of time a company's logo or product is visible within the video stream. This measure of net screen space is one of the predefined impression parameters captured and measured by the system. Additionally, the collection of characteristics and requirements can be dynamic, allowing the requestor to use parameters that are pre-populated or create new and different requirements as required to fit their needs.

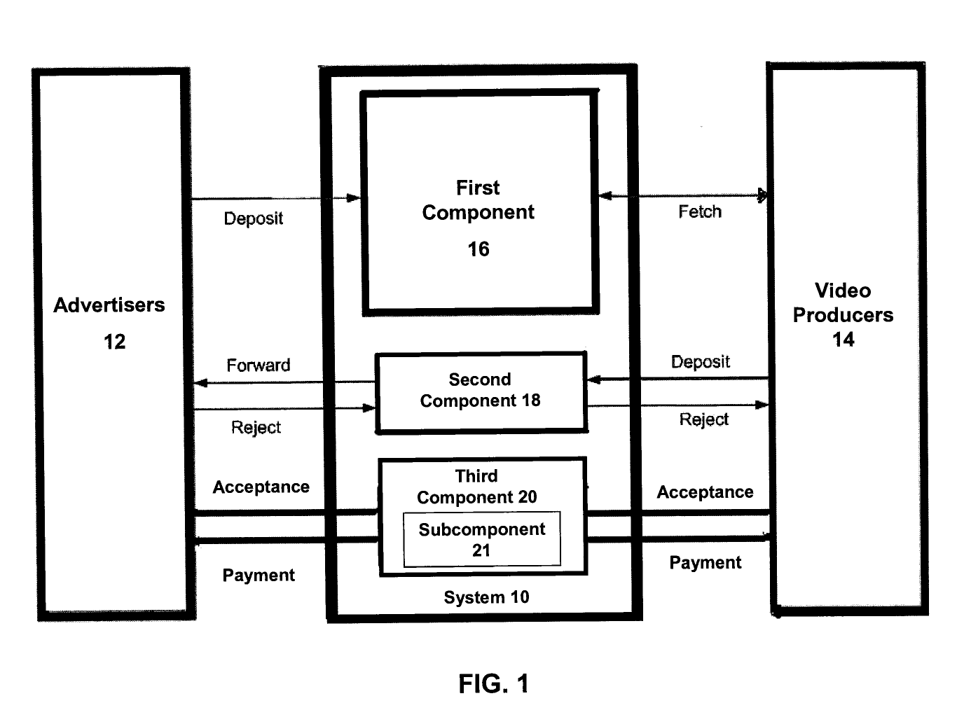

As shown in FIG. 1, the system 10 acts as a marketplace that enables transactions between advertisers 12 and video producers 14 in a seamless manner. According to the embodiment shown in FIG. 1, the system 10 includes components 16, 18, and 20. Component 16 is a device, such as a computer server, that holds a set of requests for production of advertisement video, wherein each request comprises of a set of specified requirements and parameters supplied by the requesting advertiser. Component 16 is accessible to the video producers 14 wherein the producers 14 can search and select one or more of the video requests. Component 18 can be a computer server including programmed instructions that receives the produced videos from the producers 14 and evaluates them based on the specified requirements and parameters provided by the advertiser 12. If the evaluation leads to an acceptable result, then the video is forwarded to the advertiser 12 for approval. Otherwise, the video is sent back to the video producer 14 who produced the video. Component 20 is a computer server with programmed instructions responsible for receiving the acceptance of any video approved by the advertisers 12, and forwarding the acceptance to the video producer 14. Component 20 also keeps track of the corresponding statistics in regards to the viewing of the videos by consumers via its subcomponent 21. For example, subcomponent 21 keeps track of how many people viewed the video. Based on such statistics, component 20 charges the advertisers, and then subtracts certain costs and commissions due, and then forwards the remaining balance to the advertiser. In at least one embodiment, components 16, 18, and 20 are one computer server with the functions of components 16, 18, and 20 programmed into operational modules in software. In at least another embodiment, components 16, 18, and 20 are distributed across: a network and are located in different places.

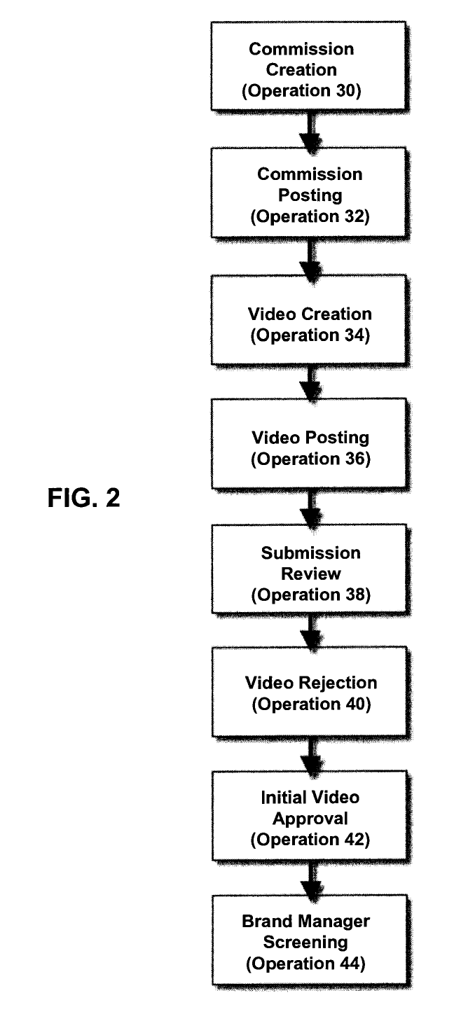

FIG. 2 illustrates exemplary operations performed in a method of advertising management and evaluation. Additional, fewer, or different operations may be performed depending on the particular implementation. In an operation 30, a brand manager or advertiser creates a commission and defines a set of specifications including requirements and impression parameters. In an operation 32, active commissions are posted on a server where video producers can decide which commissions to pursue. In an operation 34, video producers create videos using the requirements defined by the commission definition, including impression parameters.

Once a video has been created, an operation 36 is performed in which the video is posted to the web by the video producer and a submission is: created linking that video to a specific commission. In an operation 38, submitted videos are assigned to a customer service representative for content review. Using the requirements and impression parameters defined in the setup of the commission, the submissions are accepted or rejected. While this operation is described as a manual step, it may be automated, as described later.

In an operation 40, if a video does not meet the initial requirements, it is rejected and is returned to the video producer. An e-mail may be generated to inform the video producer of the rejection as well as the reasons for it. In an operation 42, if a video meets all the requirements defined within the commission, the video is approved by a screener and the video then passes onto a brand manager for review.

In an operation 44, the brand manager, who created the commission and it's related requirements, ultimately decides if the video meets all the requirements, and/or if the video meets their overall marketing objectives for the campaign. Once the video is accepted/approved, the system begins tracking the views of the content in order to calculate payment due to the video producer.

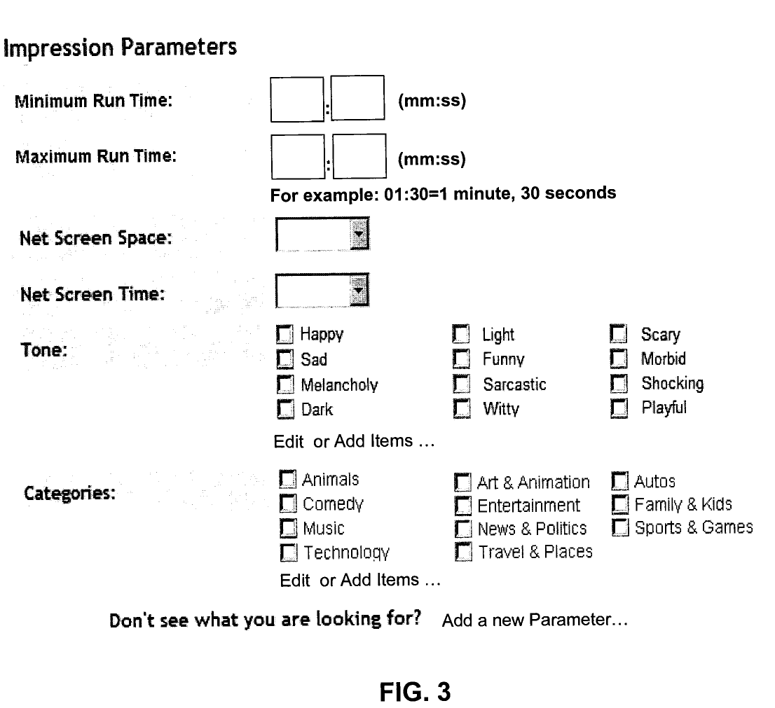

According to an embodiment, FIG. 3 is a graphical user interface used in the creation of a new commission. The graphical user interface shows how brand managers can specify impression parameters to more clearly define the preferred output for a commission. As can be seen in FIG. 3, the system incorporates several predefined characteristics, such as Run Time, Net Screen Space, Tone, and Categories. In addition, the system, also has the capability to allow the brand manager to modify existing characteristics or define entire new ones. This functionality allows for much greater flexibility in setting up a commission while maintaining rigor regarding to the future qualification or grading of the videos submitted against the commission.

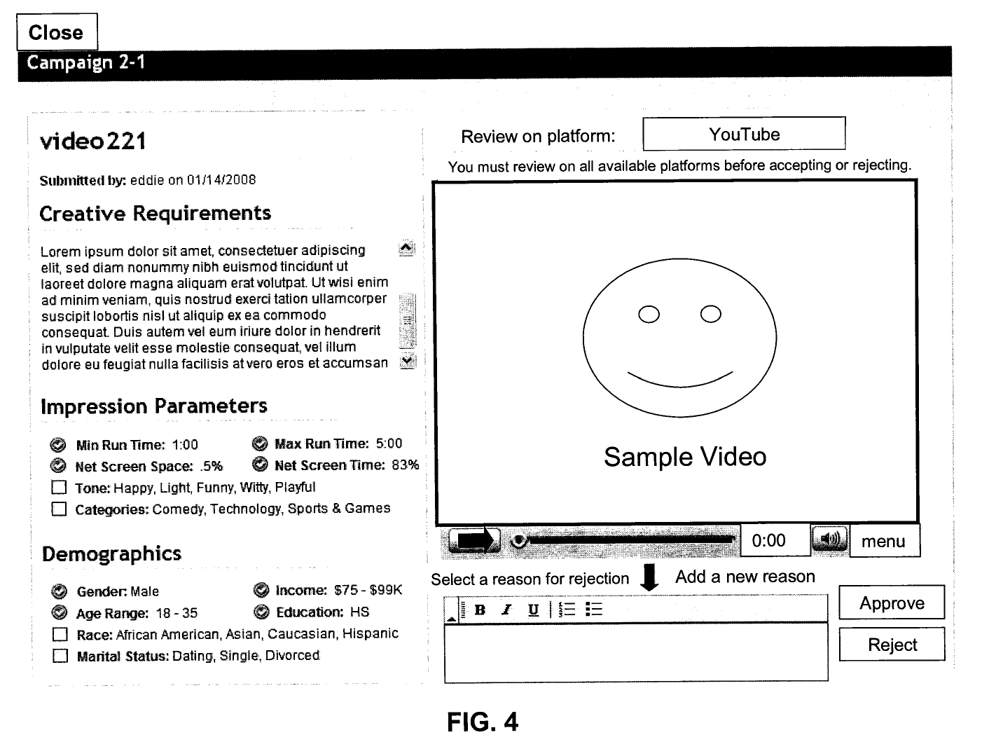

The parameters defined in the section described above are also available to the screener for use in qualifying and approving or rejecting the video, as described previously with reference to the flow diagram of FIG. 2. When a screener selects a commission to review, a window opens displaying the video(s) along with the requirements associated with that commission, as shown in FIG. 4. Some parameters can be systematically verified such as if the length of the video falls within the minimum and maximum run time. These parameters are visible in the graphical user interface depicted in FIG. 3 as the little circles with a check mark in them. Should a parameter fail to meet the predefined standard, the circle is replaced by a “X”. Other more suggestive parameters still require screener intervention, as represented above by the check boxes.

According to one embodiment, the screening for net screen space may be automated. A first operation in an embodiment of the automation process is to define the object of an image or logo. This can be done by importing a separate image file or selecting a portion of a larger image. Next, specific characteristics of the image are identified to create a specific object recognition pattern. This pattern is then used to evaluate each and every frame of the video to determine the amount of screen space that the object occupies, as a proportion to the total size of the video. The proportion from each frame is aggregated for the length of the entire, video and used to calculate the overall net screen space.

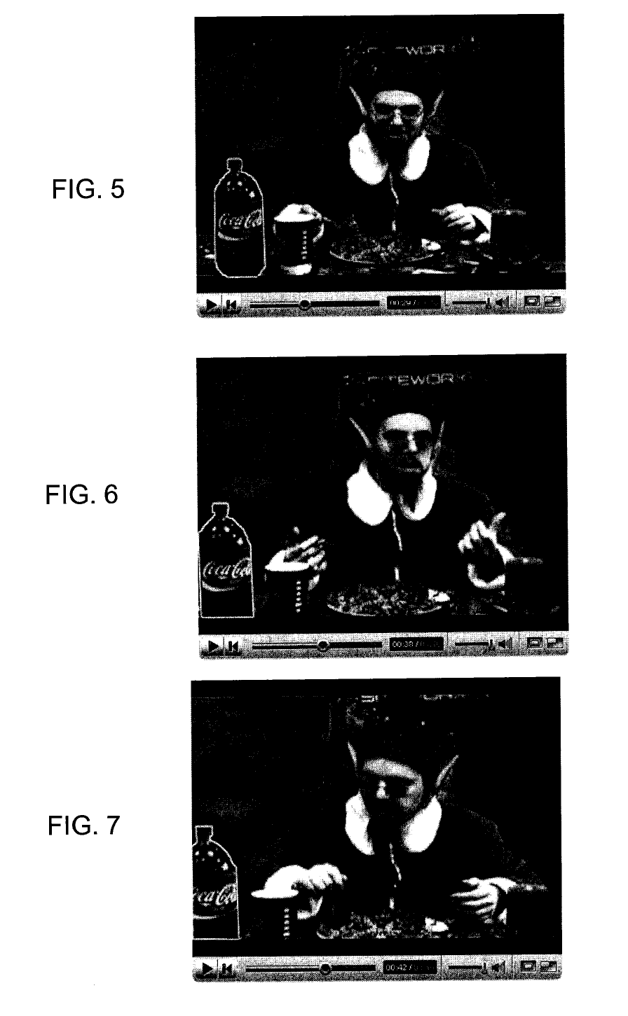

FIGS. 5, 6, and 7 illustrate the process of screening for net screen space. To begin the process, an algorithm is used to study an image of the bottle of soda to determine its characteristics including the basics of shape, color, patterns or logos, relative size, etc. This becomes the pattern used to search each frame of the video. If the pattern is found, the perimeter of the object is established and all the pixels within that parameter are counted. This pixel count is then divided by the total number of pixels in the video frame to determine the net screen space for the individual frame of video. Once this value has been determined for each frame of video, an average value: for the entire video is calculated using the values from each frame.

The still video image shown in FIG. 5 is 480 by 360 pixels, or 172,800 pixels per frame. The image of a bottle of soda within the overall video frame is comprised of a patch of 9,042 pixels. The computed net screen space for this particular frame would be 9,042÷172,800, or 5.23%. As the video plays, the camera zooms in and therefore the bottle becomes larger and occupies a greater proportion of the video. In a subsequent frame (shown in FIG. 6), the bottle of soda takes up 9,177 pixels or 5.31% of the video frame. However, after 34 seconds, the bottle begins to be cut off and the number of pixels is reduced. By 42 seconds into the video. (FIG. 7), the bottle comprises, 7,239 pixels or 4.19% of the video frame. Ultimately, the video pans in to the extent that the bottle of soda is no longer visible within the frame and the net screen space value is reduced to zero. Once the net screen space has been calculated for each frame, those individual values are summed and divided by the total number of frames in the video to produce an overall net screen space value.

Net screen time is calculated in a similar fashion in that it uses the same pattern to search each frame of video. But instead of calculating the percent of screen space, it simply derives a binary Yes/No as to indicate, the existence of the objects in a frame. If the object is found, the process returns a 1 for that particular frame. If the object is not found, the process returns a zero. The process then accumulates the total number of frames in which the object is found. The total count of frames with the object is divided by the product of the length of the video and the video's frame rate. The output is the net screen time. The video described above is 1 minute and 0.10 seconds long and has a frame rate of 30 frames per second, resulting in 2,100 frames. The bottle of soda is displayed in 1,020 frames of the total 2,100 frames for a net screen time of 48.57%.

The foregoing description of exemplary embodiments has been, presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to, explain the principles of the present invention and its practical application to enable one skilled in the art to utilize the present invention in various embodiments and with various modifications as are suited to the particular use contemplated.

What is claimed is:

1. An advertisement evaluation method comprising:
receiving a produced advertisement from a producer;
evaluating the advertisement based on a set of specified requirements and parameters;
producing a result of the evaluation; and
forwarding the advertisement to an advertiser if the result is acceptable; and returning the advertisement to the producer if the result is not acceptable.

2. The method of claim 1, wherein the parameters are impression parameters.

3. The method of claim 1, wherein the parameters are defined by advertisers.

4. The method of claim 1, wherein the parameters are predefined.

5. The method of claim 1, wherein the set of specified requirement is comprised of one or more of 1) a project objective, 2) a target market, or 3) a value proposition.

6. The method of claim 2,
wherein impression parameters are comprised of one or more of 1) a percentage of the screen that a product is displayed in the advertisement, 2) an amount of time the product is shown in the advertisement, 3) a time length of the advertisement, 4) a tone of the advertisement, or 5) a size of advertisement.

7. The method of claim 1, wherein the method is automated.

8. The method of claim 1, wherein the method is implemented online.

9. An advertisement evaluation system comprising:
a device configured to receive a produced advertisement from a producer;
a device configured to evaluate the advertisement based on a set of specified requirements and parameters and to produce a result; and
a device configured to forward the advertisement to an advertiser if the result is acceptable; and to return the advertisement to the producer if the result, is not acceptable.

10. The system of claim 9, wherein the parameters are impression parameters.

11. The system of claim 9, wherein the parameters are defined by advertisers.

12. The system of claim 9, wherein the parameters are predefined.

13. The system of claim 9,
wherein the set of specified requirement is comprised of one or more of 1) a project objective, 2) a target market, or 3) a value proposition.

14. The method of claim 10,
wherein impression parameters are comprised of one or more of 1) a percentage of the screen that a product is displayed in the advertisement, 2) an amount of time the product is shown in the advertisement, 3) a time length of the advertisement, 4) a tone of the advertisement, or 5) a size of advertisement.

15. The system of claim 9, wherein the method is automated.

16. The system of claim 9, wherein the method is implemented online.

17. An advertising management method comprising:
receiving a request for a desired advertisement from an advertiser, wherein the request comprises of a set of specified requirements for the desired advertisement;
forwarding the request to a producer if the request selected by the producer;
producing the selected advertisement according to the specification; evaluating the advertisement based on the specified requirements and a set of parameters;
reviewing the advertisement by the advertiser;
displaying the accepted advertisement;
tracking the performance of the accepted advertisement;
charging the advertiser based on the performance;
receiving a payment for the charges; and
forwarding at least a portion of the payment to the producer.
